(19) United States
(12) Patent Application Publication
(10) Pub. No.: US 2009/0016878 A1
(43) Pub. Date: Jan. 15, 2009

(54) FAN AND FRAME THEREOF

(75) Inventors: Wei-Pang HUANG, Taoyuan Hsien (TW); Chung-Yuan Tsang, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/168,593

(22) Filed: Jul. 7, 2008

(30) Foreign Application Priority Data
Jul. 10, 2007 (TW) 96125037

(51) Int. Cl. F03D 11/04

(52) U.S. Cl. 415/213.1

(57) ABSTRACT

A fan including a frame and an impeller is provided. The frame includes a main body and a base. The base includes a shaft tube part and at least one vibration-reducing structure. The impeller is disposed on the shaft tube part. The shaft tube part extends from the base. The vibration-reducing structure is formed as one part of the base and is made of at least one high damping material for absorbing vibration during operation of the fan.

### CROSS REFERENCE TO RELATED APPLICATIONS

This Application claims priority of Taiwan Patent Application No. 096125037, filed on Jul. 10, 2007, the entirety of which is incorporated by reference herein.

### BACKGROUND OF THE INVENTION

1. Field of the Invention

The present invention relates to a fan and a frame thereof, and more particularly to a fan and a frame thereof which decreases fan vibration and noise, improves stability, and increases air flow area.

2. Description of the Related Art

Many apparatuses, for example the network servers, need a fan to rapidly dissipate heat. However, to choose a fan with high performance, in addition to heat-dissipating ability of the fan, fan vibration is also an important issue for users to consider. Especially for an apparatus requiring stable operations, fan vibration can cause the apparatus to operate unstably and to be easy to malfunction. Thus, the design for decreasing fan vibration is one of important issues that affect the quality of fans.

Referring both to FIGS. 1A and 1B, FIG. 1A is a schematic illustration showing a conventional centrifugal fan combined with an absorbing vibration material, and FIG. 1B is a schematic illustration showing a conventional axial fan combined with an absorbing vibration material. No matter the centrifugal fan or the axial fan, the absorbing vibration materials 13a and 13b such as a rubber or a foam rubber, are respectively connected on the edges of the frames 10a and 10b of the fans 1A and 1B to decrease vibrations and prevent vibrations of the fans 1A and 1B to be transmitted to the apparatus. However, using the above fan designs results in a difficult assembly processes. Moreover, the absorbing vibration materials 13a and 13b may deform or break easily. When the fan 1A or 1B break, it is difficult to replace the fan. Also, using the absorbing vibration materials will affect airflow area of the fans 1A and 1B so as to cause insufficient airflow.

### BRIEF SUMMARY OF INVENTION

A detailed description is given in the following embodiments with reference to the accompanying drawings. The present invention provides a fan and a frame thereof which can solve the problem of difficult assembly, limited applications, and insufficient airflows in conventional fans. The fan and the frame thereof of the present invention also improve the stability when the fan operates.

In order to achieve the above-mentioned goals, the present invention provides a frame having a main body and a base. The base is disposed in the main body. The base includes a shaft tube part (bushing) and at least a vibration-reducing structure. The shaft tube part (bushing) perpendicularly extends from the base. The vibration-reducing structure is one part of the base and is made of at least a high damping material.

The present invention also provides a fan having a frame and an impeller. The frame has a main body and a base. The base is disposed in the main body. The base includes a shaft tube part (bushing) and at least a vibration-reducing structure. The shaft tube part (bushing) perpendicularly extends from the base. The vibration-reducing structure is one part of the base. The impeller is disposed on the shaft tube part (bushing). The vibration-reducing structure is made of at least a high damping material.

The vibration-reducing structure surrounds the shaft tube part (bushing) of the fan and the frame thereof of the present invention. The main body includes a plurality of fixing portions to fix the frame on an external system. The external system can be a desk host, a mainframe, a server, a vehicle control system, a multimedia electronic mechanism, or a wireless communications station. A plurality of vibration-reducing structures are disposed on the base. The vibration-reducing structures are correspondingly installed between the fixing portions and the shaft tube part (bushing). The fixing portions include a screw, a rivet, a budding structure, an adhesive, and a wedging structure to fix the base on the external system. The vibration-reducing structure is manufactured by injection molding or poured glue. In other words, the vibration-reducing structure is a molded injection structure or a poured glue structure. The vibration-reducing structure is circular, rectangular, triangular or irregular shaped. The material of the vibration-reducing structures is the same as a part of the base or completely different from the base. The high damping material includes a silicone, a rubber, a plastic, a foam rubber or other materials. The frame is applied to an axial fan or a centrifugal fan. The shaft tube part (bushing) holds an impeller. The impeller generates airflow.

### BRIEF DESCRIPTION OF DRAWINGS

The present invention can be more fully understood by reading the subsequent detailed description and examples with references made to the accompanying drawings, wherein:

FIG. 1A is a schematic illustration showing a conventional centrifugal fan combined with a absorbing vibration material;

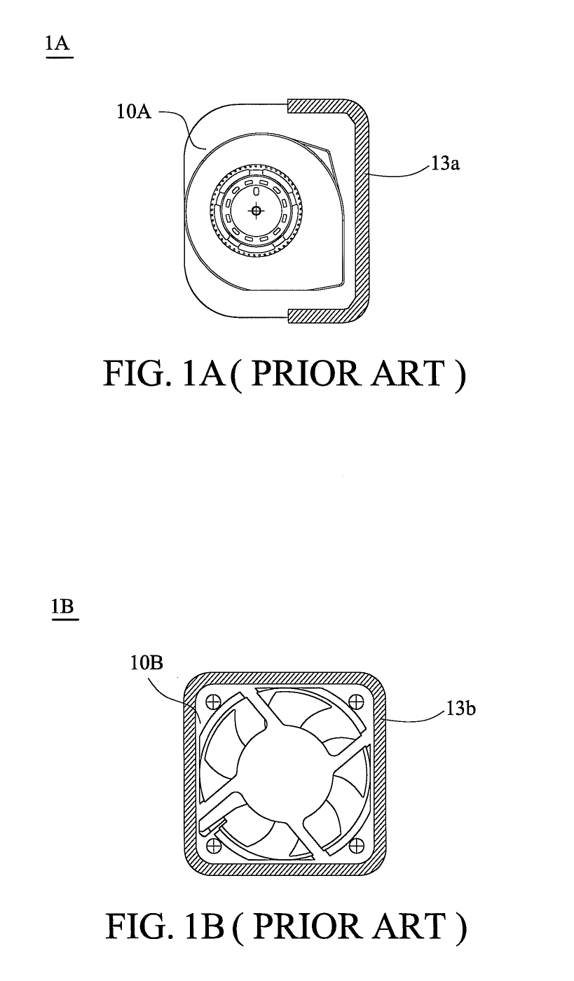

FIG. 1B is a schematic illustration showing a conventional axial fan combined with a absorbing vibration material;

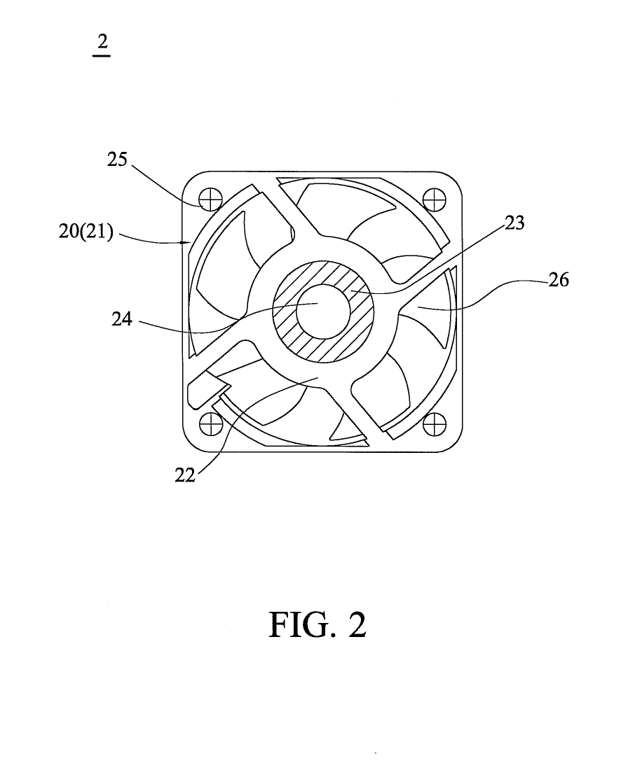

FIG. 2 is a schematic illustration of a fan according to the preferred embodiment of the present invention;

FIGS. 3A and 3B are schematic illustrations showing another two vibration-reducing structures of the present invention.

### DETAILED DESCRIPTION OF INVENTION

The following description is of the best-contemplated mode of carrying out the present invention. This description is made for the purpose of illustrating the general principles of the present invention and should not be taken in a limiting sense. The scope of the present invention is best determined by reference to the appended claims.

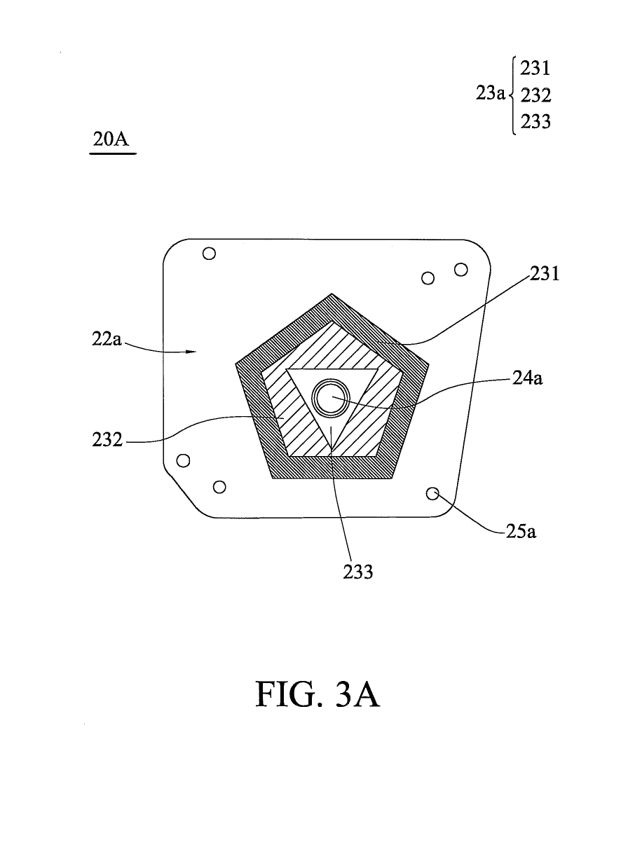

Referring to FIG. 2, FIG. 2 is a schematic illustration of a fan according to the preferred embodiment of the present invention. The fan 2 includes a frame 20 and an impeller 26. The frame 20 includes a main body 21 and a base 22. The base 22 is disposed in the main body 21 and includes a shaft tube part (bushing) 24 and a vibration-reducing structure 23. The shaft tube part (bushing) 24 perpendicularly extends from the base 22. The vibration-reducing structure 23 is one part of the base 22 and is made of at least one high damping material, for example a silicone, a rubber, a plastic, a foam rubber or other materials. In addition, the vibration-reducing structure 23 surrounds and encircles the shaft tube part 24, and the shaft tube part 24 supports and holds the impeller 26.

The impeller 26 is disposed on the shaft tube part (bushing) 24 to rotate for generating airflows. Also, the frame 20 includes a plurality of fixing portions 25 located around a periphery, of the base to fix the frame 20 on an external system. The external system is a desk host, a mainframe, a server, a vehicle control system, a multimedia electronic mechanism, or a wireless communication station. The fixing portions 25 can be a screw, a rivet, a buckling structure, an adhesive, or a wedging structure to fix the fan 2 on the external system. Moreover, the fan can also be fixed to the external system via an adhesive structure or a wedging structure.

To improve stability and solve the problems of noise generated by vibration of the fan 2 in external systems, the vibration-reducing structure 23 is formed on the area where the vibration is transmitted, for example, the area around the shaft tube part (bushing) 24 by injection molding or poured glue when manufacturing the main body 21. Thus, when the fan 2 operates, vibration generated by the impeller 26 first passes through the vibration-reducing structure 23 surrounding the shaft tube part (bushing) 24, and then is transmitted to the main body 21. Because the vibration-reducing structure 23 is made by at least one high damping material, the vibration transmitted by the shaft tube part (bushing) 24 is absorbed by the vibration-reducing structure 23 and is not transmitted to the fixing portions 25. Thus, the external system is not subjected to vibrations.

Also, because the main body 21 itself can decrease vibration, thus, the fan 2 does not require extra space to assemble absorbing vibration material with the main body 21. Therefore, airflow area would not be affected and heat dissipation efficiency is enhanced.

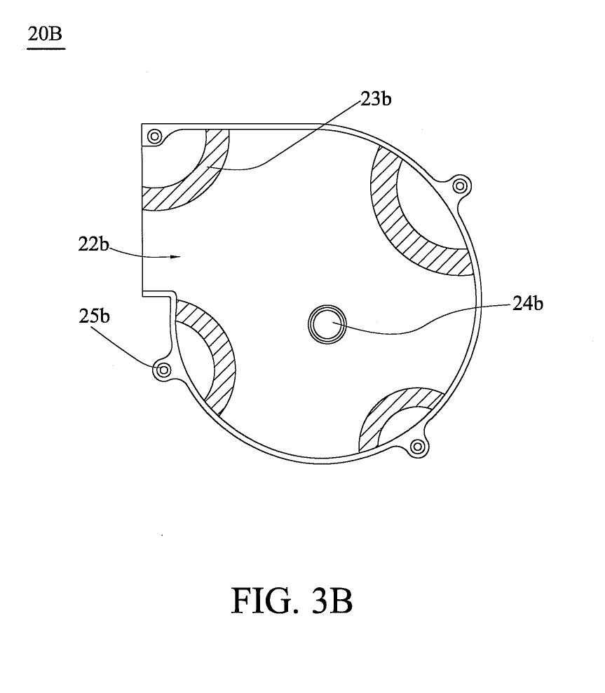

Furthermore, the vibration-reducing structure 23 is not limited to a single material. Referring to FIG. 3A, FIG. 3A is a schematic illustration of another embodiment of a vibration-reducing structure of the present invention. The vibration-reducing structure 23a can be made of various materials different from the base 22a. The vibration-reducing structures 231, 232 and 233 are made of different damping materials (from high damping material to low damping material) connected to each other. The vibration-reducing structures 231, 232 and 233 surround and encircle the shaft tube part 24a to absorb the vibration from the shaft tube part 24a. To decrease the amount of the types of materials to be used, materials are alternated between the same material as that of the base 22a and a different material. For example, the material of tie vibration-reducing structure 233 is the same as that of the base 22a. The materials of the vibration-reducing structure 231 and 232 are different from that of the base 22a. No matter how the materials are composed, the present invention discloses high and low damping materials connected to each other for absorbing vibrations and limiting vibrations transmitting to the fixing portions 25a.

As shown in FIG. 3A, the vibration-reducing structure 23a can be formed as different shapes such as a circular, rectangular, triangular or irregular shape according to requirements.

Referring to FIG. 3B, FIG. 3B is a schematic illustration of another embodiment of a vibration-reducing structure of the present invention. In this embodiment, the vibration-reducing structure 23b does not surround and encircle the shaft tube part 24b. The vibration-reducing structure 23b is installed between the shaft tube part (bushing) 24b and the fixing portions 25b. Namely, the vibration-reducing structure 23b surrounds the fixing portions 25b. The material and shape of the vibration-reducing structure 23b can be similar to those of the embodiment in FIG. 3A, thus, description is omitted for brevity. When the impeller 26 rotates, the vibration from the impeller 26 is absorbed by the vibration-reducing structure 23b adjacent to the fixing portion 25b. Thus, the vibration-reducing structure 23b can decrease vibration. The amount of the vibration-reducing structure 23b can be increased or decreased according to practical applications. The present invention not only decreases vibration but also increases manufacturing flexibility.

In conclusion, the vibration-reducing structures 23, 23a and 23b of the present invention decreases fan vibration, noise, and improve stability. The vibration-reducing structure on the main body is used flexibly and provides large airflow area. No matter the vibration-reducing structure surrounds the shaft tube part (bushing) or is installed between the shaft tube part (bushing) and the fixing portion, vibrations will be isolated. Thus, heat-dissipating efficiency is enhanced whether the fan is an axial fan or a centrifugal fan.

While the present invention has been described by way of example and in terms of the preferred embodiments, it is to be understood that the present invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A frame of a fan, comprising:
a main body; and
a base disposed in the main body, comprising:
a shaft tube part substantially perpendicularly extending from the base; and
at least one vibration-reducing structure, which is one part of the base and is made of at least one high damping material.

2. The frame as claimed in claim 1, wherein the vibration-reducing structure surrounds and encircles the shaft tube part, and the shaft tube part supports and holds an impeller.

3. The frame as claimed in claim 1, wherein the main body comprises a plurality of fixing portions located around a periphery of the base to fix the frame on an external system.

4. The frame as claimed in claim 3, wherein there is more than one vibration-reducing structure, and the vibration-reducing structures are correspondingly installed between the fixing portions and the shaft tube part, respectively.

5. The frame as claimed in claim 3, wherein the fixing portions comprise a screw, a rivet, a budding structure, an adhesive, or a wedging structure.

6. The frame as claimed in claim 1, wherein the vibration-reducing structure is a formed by injection molding or poured glue.

7. The frame as claimed in claim 1, wherein each of the vibration-reducing structures comprises a circular, rectangular, triangular or irregular shape.

8. The frame as claimed in claim 4, wherein the material of some of the vibration-reducing structures is the same as a part of the base and the main body.

9. The frame as claimed in claim 1, wherein the material of the vibration-reducing structures is completely different from the base.

10. The frame as claimed in claim 1, wherein the high damping material comprises a silicone, a rubber, a plastic, or a foam rubber.

11. A fan, comprising:
a frame comprising a main body and a base disposed in the main body, wherein the base comprises a shaft tube part and at least one vibration-reducing structure, the shaft tube part substantially perpendicularly extends from the base, and at least one vibration-reducing structure which is one part of the base; and
an impeller disposed on the shaft tube part;
wherein the vibration-reducing structure is made of at least one high damping material.

12. The fan as claimed in claim 11, wherein the vibration-reducing structure surrounds and encircles the shaft tube part.

13. The fan as claimed in claim 11, wherein the main body comprises a plurality of fixing portions located around a periphery of the base to fix the frame on an external system.

14. The fan as claimed in claim 13, wherein the external system is a desk host, a mainframe, a server, a vehicle control system, a multimedia electronic mechanism, or a wireless communication station.

15. The fan as claimed in claim 13, wherein there is more than one vibration-reducing structure, and the vibration-reducing structures are correspondingly installed between the fixing portions and the shaft tube part, respectively.

16. The fan as claimed in claim 13, wherein the fixing portions comprise is fixed to tie external system via a screw, a rivet, a buckling structure, an adhesive, or a wedging structure.

17. The fan as claimed in claim 11, wherein the vibration-reducing structure is formed by injection molding or poured glue, and the vibration-reducing structure is circular, rectangular, triangular or irregular.

18. The fan as claimed in claim 11, wherein the material of some of the vibration-reducing structures is the same as a part of the base.

19. The fan as claimed in claim 11, wherein the material of the vibration-reducing structures is completely different from the base.

20. The fan as claimed in claim 14, wherein the fan is an axial fan or a centrifugal fan, and the high damping material comprises a silicone, a lubber, a plastics, or a foam rubber.
